(19) United States
(12) Patent Application Publication
(10) Pub. No.: US 2007/0116192 A1
(43) Pub. Date: May 24, 2007

(54) Apparatus and method for instant voice messaging

(76) Inventors: Justin Cutshall, Glen Rock, PA (US); Kirk Steffke, Cresson, PA (US)

Correspondence Address: GERALD J. CECHONY, 7701 MCCALLUM STREET, PHILADELPHIA, PA, 19118, US

(21) Appl. No.: 11/254,015

(22) Filed: Oct. 19, 2005

(51) Int. Cl. H04M 1/64

(52) U.S. Cl. 379/67.1

(57) ABSTRACT

A mobile telephone with which a user may send a voice message to another subscriber instantly and independently of any other functions. In facilitation of the invention, a dedicated key is provided on the telephone. In an alternative embodiment, innovative menus are provided to support a method of the invention.

### FIELD OF THE INVENTION

This invention pertains to telephone networks, and particularly to voice messaging via wireless telephone networks.

### BACKGROUND OF THE INVENTION

Wireless telephones have become ubiquitous in recent years. Unlike landline phones which for the most part have traditionally been limited to passive paths for enabling live voice conversations, wireless telephones tend to be incorporate microprocessors and thus to provide many innovative capabilities, including the taking, storage and forwarding of pictures; text messaging; voice messaging; games; “juke box” functions; appointment calendars; address-book functions, and so on.

A sender on a wireless phone may “push” a text message. That is, he may cause the text message to be received by a recipient's phone instantly if the recipient's phone is turned on, or as soon as the recipient's phone is subsequently turned on.

Voice messages, however, may not be pushed; rather they may be left for a recipient only ancillarily to other functions: 1) a sender is given the opportunity to leave a voice message for a recipient after the sender has attempted a voice call to the recipient and the recipient did not answer; 2) a sender forwarding a picture may have the opportunity to forward a voice commentary along with the picture.

It is thus an object of the present invention to provide a simple way for a user to push a voice message to a recipient, without dependence on any other functions.

This and other objects of the invention will be apparent to those skilled in the art from the following description thereof.

### SUMMARY OF THE INVENTION

The present invention overcomes these drawbacks of the prior art by providing for the pushing of voice messages. One embodiment provides a pushbutton on a user's phone for initiating an instant voice message. An alternative embodiment provides a compact menu structure implemented in the user's phone's hardware, firmware, and software providing for the pushing of voice messages.

The present invention provides a method of sending an instant voice message from a first telephone to at least one second telephone on a telephone network, comprising the steps of: providing a menu option on the first telephone for a user to request sending of an instant voice message; accepting and storing at the first telephone the instant voice message from the user; accepting in the first telephone and associating with the instant voice message at least one telephone number, each identifying one certain second telephone; providing the instant voice message and at least one telephone number to the telephone network; informing a recipient at a certain second telephone of the instant voice message; accepting from the recipient a request to play the instant voice message on the certain second telephone; retrieving the instant voice message to the certain second telephone; and playing the instant voice at the certain second telephone.

The invention will next be described in regard to several exemplary embodiments; it will, however, be clear to those in the art that enhancements, modifications, and subtractions can be made without departing from the spirit or scope of the claims.

### BRIEF DESCRIPTION OF THE DRAWINGS

The invention will be more clearly understood from the ensuing description of certain embodiments, in conjunction with following drawings, wherein:

FIG. 1 (Prior Art) is a block diagram of actions between a sender's phone and a recipient's phone when a sender attempts to initiate a voice call;

FIG. 2 (Prior Art) is a block diagram of actions between a sender's phone and a recipient's phone when a sender initiates a text message;

FIG. 3 (Prior Art) is a block diagram of actions between a sender's phone and a recipient's phone when a sender initiates sending of a picture;

FIG. 4 is a high-level block diagram of actions between a sender's phone and a recipient's phone when a sender pushes a voice message according to the present invention;

FIGS. 5 through 7 show further detail of the actions depicted in FIG. 4;

FIGS. 8 through 17 depict screens displayed on a sender's phone while executing functions depicted in FIGS. 5 through 7.

### DESCRIPTION OF THE INVENTION

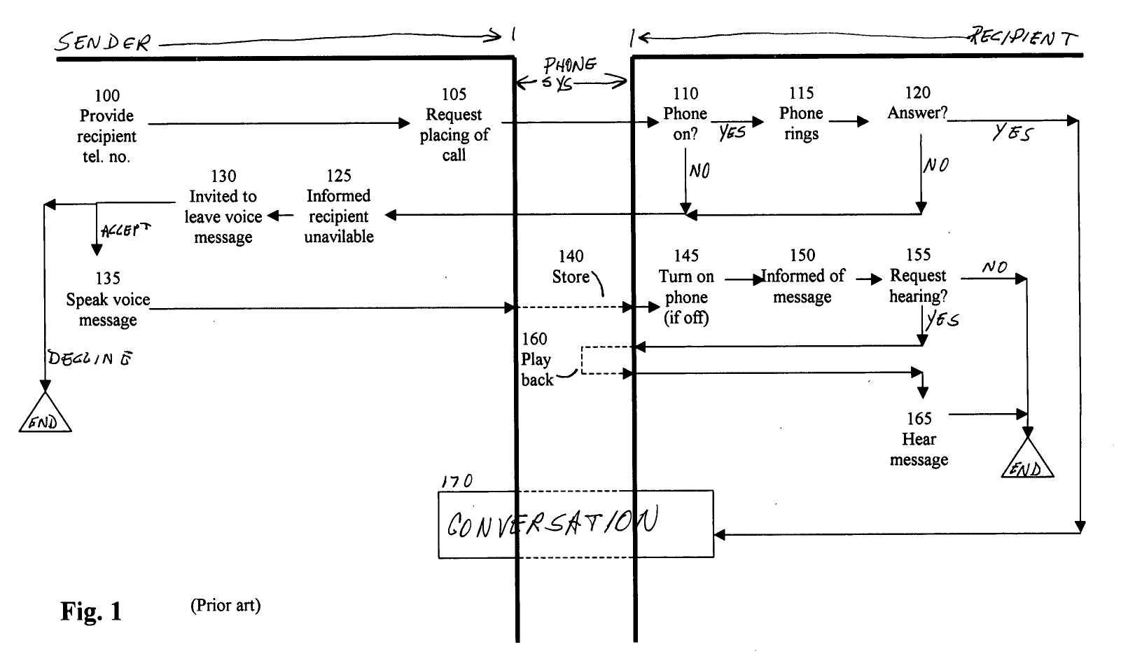

FIG. 1 depicts the sequence of a user attempting to initiate a voice telephone call on a mobile phone of the prior art. In block 100 the sender provides a telephone number of his intended recipient. He may do this by keying in the number at that time, or causing it to be retrieved from a list of numbers prestored in his phone, as is well known in the art. In block 105 he requests placement of the call by pressing a predetermined button on his phone.

The call is routed by the telephone system by means well known in the art and not discussed here. The telephone system may include, without limitation, the sender's telephone service provider, the intended recipient's telephone service provider, and the public switched telephone network (PSTN).

In block 110, if the recipient's telephone is turned on, flow dispatches to block 115 in which the recipient's phone provides the recipient some indication that an attempt is being made to call him—his telephone does a predetermined operation such as ringing or vibrating.

In block 120, if the user “answers” the call (usually by pressing a predetermined key) the flow dispatches to block 170—the user and the recipient converse in real time via the phone system.

Contrary to the above, if in block 110 it is determined that the recipient's phone is not turned on, or if in block 120 the recipient does not answer his phone, the telephone system is directed to dispatch to block 125 in which the user is informed that the recipient is not available, and then to block 130 in which the user is invited to leave a voice message. In block 135 the user speaks a voice message into his telephone.

In step 140 the voice message is stored. FIG. 1 depicts this storage taking place in the telephone system, but as a design choice it might alternatively take place in the user's telephone or the recipient's telephone. Flow then passes to block 150, perhaps instantly if the recipient's telephone is already turned on, or else later when the user turns it on block 145. In block 150 the recipient is informed of the existence of the voice message and in block 155 may elect to hear it, in which case block 160 plays it back and the recipient hears it in block 165.

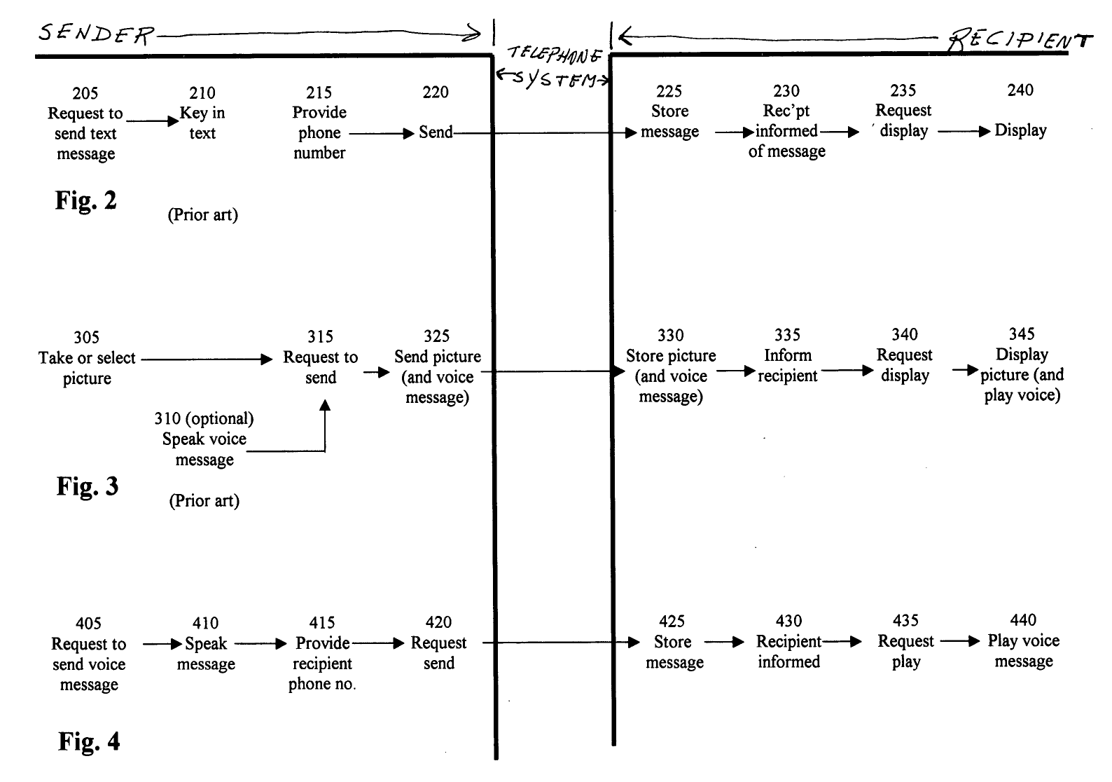

FIG. 2 depicts pushing an instant text message according to the prior art. In block 205 the user requests to send a text message. In block 210 he is invited to key it in and does so. In block 215 he provides a recipient phone number (either by keying it in currently or selecting it from among prestored numbers) and in block 220 he requests sending of it. In block 225 the message is stored (perhaps in the sender's phone, perhaps in the telephone system, perhaps in the recipient's phone (shown). In block 230 the recipient is informed of the text message (perhaps instantly, or alternatively after he has turned on his phone). In block 235 he requests to view the message, and in block 240 it is displayed to him on a screen of his telephone.

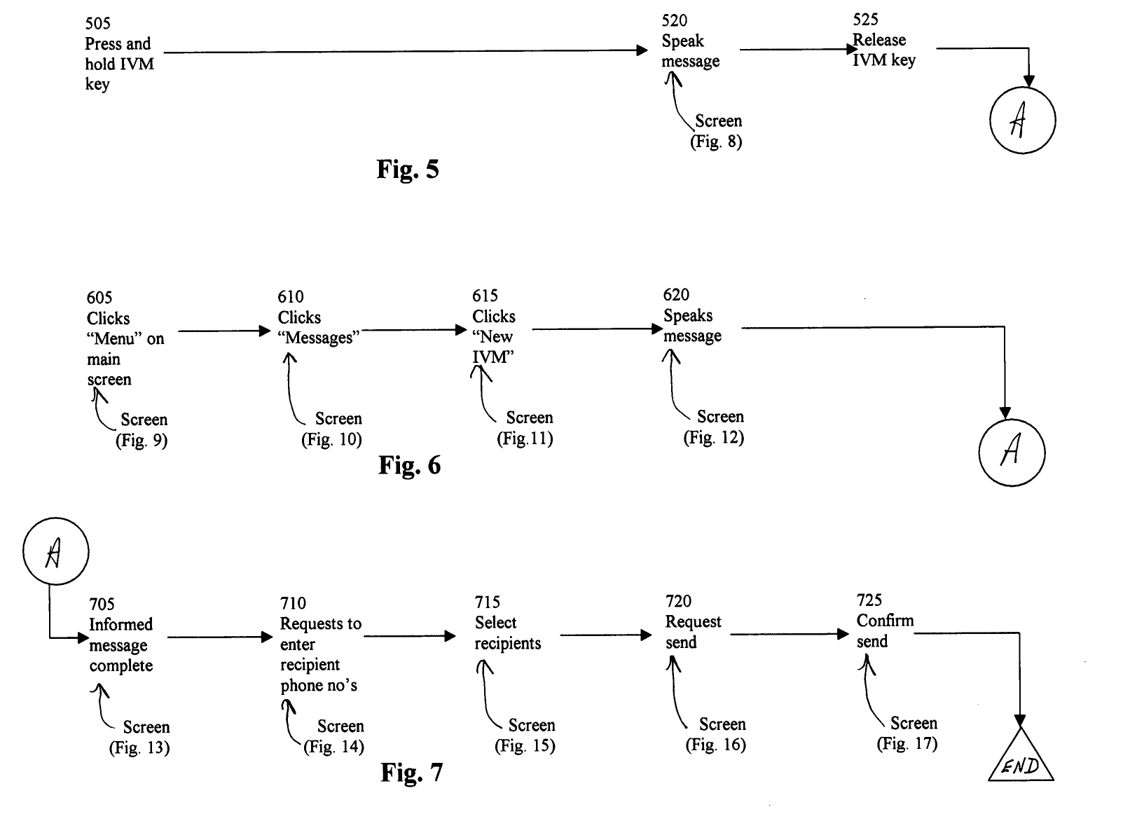

FIG. 3 depicts a sender's initiation of a picture transmission according to the prior art. In block 305 the sender, equipped with a “picture phone” or “camera phone” (well known in the art), takes a picture or selects a previously taken and prestored picture. In block 310 he is given the option to send a voice message along with the picture, and may record same into his phone. In block 325 he requests to send the picture.

In block 330 the picture (and voice message, if any) are stored (in the user's phone, in the telephone system, or in the recipient's phone (shown). In block 335 the recipient is informed of the picture, and in block 340 may request display of the picture. In block 345 the picture is displayed on a screen on the recipient's telephone; simultaneously, the voice message (if any) is played to the user.

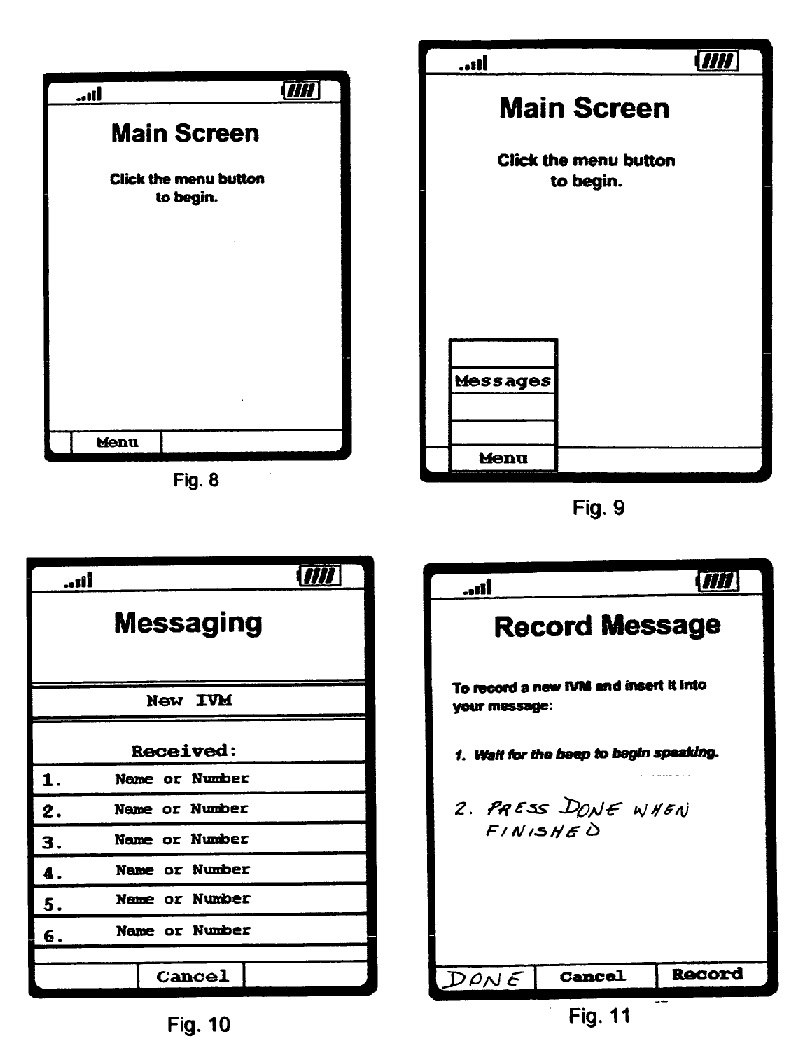

Nothing in the prior art allows a sender to push an instant voice message to a recipient simply and without being subservient to other functions (i.e., an unanswered voice call or a picture message). FIG. 4 depicts the solution provided by the present invention. In block 405 the sender requests sending an instant voice message. In block 410 he speaks the message into his telephone where it is recorded. In block 415 he provides a recipient telephone number, either by keying it or selecting it from among prestored numbers. In block 420 the sender requests that the message be sent. In block 425 the voice message stored, alternatively in the sender's telephone, the telephone system, or the recipient's telephone (as shown). In block 430 the recipient is informed of the voice message, and in block 435 he may request that the message be played, which will dispatch to block 440 and play the message.

In a preferred embodiment of the present invention, a sender's telephone is equipped with a separate key (here called the Instant Voice Message (IVM) key) for initiating the sending of a voice message. In an alternative embodiment of the present invention, a sender's telephone does not have an IVM key but instead is provided with enhanced menus (described below) in support of the IVM function.

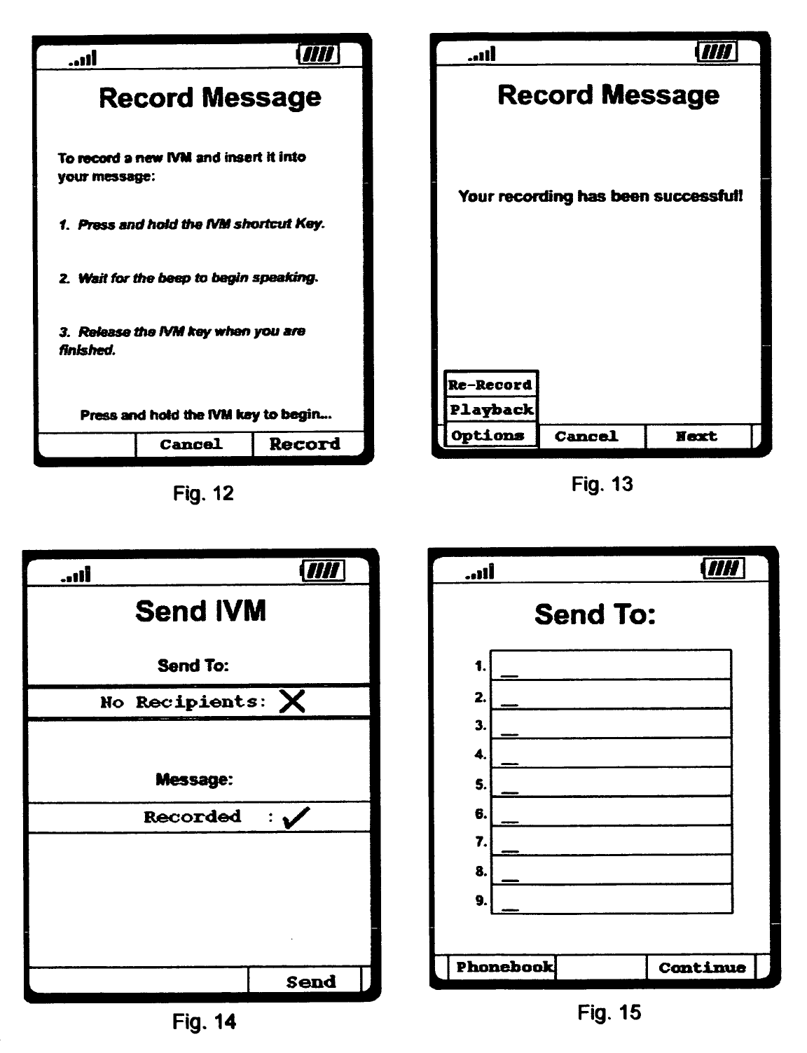

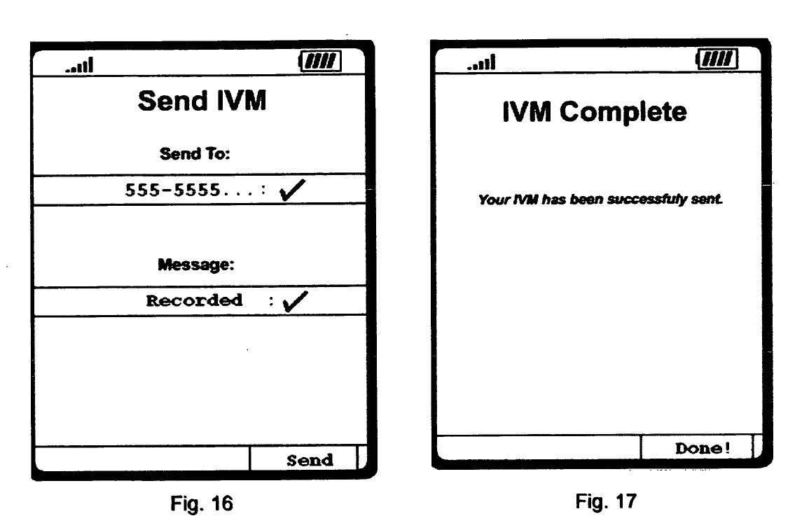

FIGS. 5 and 7 depict further detail of the operation of the present invention on a user's telephone equipped with an IVM key. Referring first to FIG. 5, in block 505 the user presses and holds the IVM key. In block 520 he is prompted, such as by a screen as depicted in FIG. 8, to speak his message into his telephone for recording and to release the IVM key when he has spoken the entire message. In block 525 he releases the IVM key, and flow passes (as denoted by connector “A” on FIG. 5) to block 705 of FIG. 7. FIG. 7 will be discussed further below.

FIGS. 6 and 7 depict further detail of the operation of the present invention on a user's telephone either not equipped with an IVM key or with an IVM key but where the sender elects to use the aforementioned special menus. Referring first to FIG. 6, in block 605 the sender is shown a screen such as that depicted in FIG. 9. He clicks MENUS, and as depicted in FIG. 10 a popup menu appears which includes (among other things, not shown) the legend MESSAGES. As shown in block 610 the sender clicks MESSAGES. In block 615 the sender is shown a screen such as that of FIG. 11 on which he sees a list of previously received and stored incoming messages, and on which he may request NEW IVM. When he clicks NEW IVM control passes to block 620, in which he is prompted on a screen such as that shown in FIG. 12 to speak his voice message into his telephone and to signal when completed. As denoted by the connector A on FIG. 6, control then passes to block 705 in FIG. 7.

With reference to FIG. 7 (reached from either FIG. 5 or FIG. 6, as noted above), the sender is informed that his message has been successfully recorded. In an embodiment of the invention this is accomplished by displaying a screen such as shown in FIG. 13, on which the sender is offered options to play back his message for confirmation or to re-record it. When he clicks NEXT, control passes to block 710. Here he is shown a screen such as the one shown in FIG. 14 on which he is reminded that he has not yet selected recipients for the voice message. Should he click NO RECIPIENTS he is dispatched to block 715 where he is shown a screen such as that of FIG. 15. He may enter the phone numbers of one or more recipients by keying them in or selecting them from among prestored numbers. When he clicks CONTINJUE he is dispatched to block 720, in which he is shown a screen such as that of FIG. 16, similar to the screen of FIG. 14 except for showing confirmation of the recipient phone number(s). When he clicks SEND, the message is sent to a recipient's phone as described above in FIG. 4, blocks 425 et. seq., and the sender is shown a confirmation screen such as that of FIG. 17.

Those skilled in the art will realize that the invention may be embodied in yet other specific forms without departing from the spirit thereof. This invention is to be embraced by the appended claims and not limited by the foregoing embodiments.

What is claimed is:

1. A method of sending an instant voice message from a first telephone to at least one second telephone on a telephone network, comprising the steps of
a. providing a menu option on the first telephone for a user to request sending of an instant voice message;
b. accepting and storing at the first telephone the instant voice message from the user;
c. accepting in the first telephone and associating with the instant voice message at least one telephone number, each identifying one certain second telephone;
d. providing the instant voice message and at least one telephone number to the telephone network;
e. informing a recipient at a certain second telephone of the instant voice message;
f. accepting from the recipient a request to play the instant voice message on the certain second telephone;
g. retrieving the instant voice message to the certain second telephone; and
h. playing the instant voice at the certain second telephone.

2. The telephone according to claim 1 wherein:
in step d. the instant voice message is stored in the telephone network; and
in step g. the instant voice message is retrieved from the telephone network.

3. The telephone according to claim 1 wherein:
in step d. the instant voice message is stored in the certain second telephone; and
in step g. the instant voice message is retrieved from the second certain telephone.

4. A first telephone for sending an instant voice message over a telephone network to at least one second telephone, the first telephone comprising
requesting means for requesting entry by a user of an instant voice message;
first accepting means for accepting from the user a spoken instant voice message;
second accepting means for accepting from the user an indication of completion of the spoken instant voice message;
third accepting means for accepting from the user at least one telephone number, each identifying a certain second telephone; and
sending means for sending the instant voice message over the telephone system to each certain second telephone.

5. The first telephone of claim 4, wherein
the requesting means comprises a dedicated key.

6. The first telephone of claim 5, wherein
the second accepting means comprises means for detecting release by the user of the dedicated key.

7. A first telephone for sending an instant voice message over a telephone network to at least one second telephone, the first telephone comprising
a dedicated key for requesting entry by a user of an instant voice message;
first accepting means for accepting from the user a spoken instant voice message;
second accepting means for accepting from the user an indication of completion of the spoken instant voice message;
third accepting means for accepting from the user at least one telephone number, each identifying a certain second telephone; and
sending means for sending the instant voice message over the telephone system to each certain second telephone.

8. The first telephone of claim 7 wherein
the second accepting means comprises means for detecting release by the user of the dedicated key.
